(19) United States
(12) Patent Application Publication
(10) Pub. No.: US 2009/0219241 A1
(43) Pub. Date: Sep. 3, 2009

(54) Liquid crystal display device

(75) Inventors: Kei Tamura, Mobara (JP); Shouji Nagao, Chiba (JP); Shinichi Iwasaki, Mobara (JP); Hiroyuki Takahashi, Funabashi (JP); Toshimitsu Matsudo, Shinagawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/379,647

(22) Filed: Feb. 26, 2009

(30) Foreign Application Priority Data
Feb. 29, 2008 (JP) 2008-050417

(51) Int. Cl. G09G 3/36; G02F 1/133

(52) U.S. Cl. 345/89; 349/37

(57) ABSTRACT

A liquid crystal display device has a liquid crystal display panel which includes: a first substrate; a second substrate; a liquid crystal composition which is sandwiched between the first substrate and the second substrate; a pixel region which is formed of a plurality of pixels arranged in a matrix array on the first substrate, each pixel including a pixel electrode, a counter electrode which faces the pixel electrode in an opposed manner, and a switching element which is electrically connected with the pixel electrode; and a driver circuit which is mounted on the first substrate along a first side of the pixel region. In such a liquid crystal display device, the driver circuit is configured to rewrite a video signal in each pixel of the pixel region for every 1 frame period via the switching element, the driver circuit includes a first AC driving mode in which polarity of a video signal to be rewritten in a frame period succeeding to the 1 frame period is inverted, and a second AC driving mode in which the polarity of the video signal to be rewritten in the succeeding frame period is equal to polarity of the video signal in the 1 frame period, and a reference voltage of the video signal is corrected so as to decrease brightness of the pixel in the second AC driving mode.

### CLAIM OF PRIORITY

The present application claims priority from Japanese application serial No. 2008-50417, filed on Feb. 29, 2008, the content of which is hereby incorporated by reference into this application.

### BACKGROUND OF THE INVENTION

1. Field of the Invention

The present invention relates to a liquid crystal display device, and more particularly to a technique which is effectively applicable to a driver circuit of a liquid crystal display device used in a display part of a portable device.

2. Description of the Related Art

A TFT (Thin Film Transistor) -type liquid crystal display device which uses thin film transistors as active elements can display an image of high definition and hence, the TFT-type liquid crystal display device has been used as a display device of a television receiver set, a personal computer display or the like.

The liquid crystal display device includes a so-called liquid crystal display panel which is configured such that liquid crystal is sandwiched between two sheets of (pair of) substrates, wherein at least one sheet of substrate is made of transparent glass or the like. In a region of the liquid crystal display panel which is surrounded by two neighboring scanning signal lines (also referred to as gate lines) and two neighboring video signal lines (also referred to as source lines or drain lines), a thin film transistor which is turned on in response to a scanning signal from the scanning signal line and a pixel electrode to which a video signal from the video signal line is supplied via the above-mentioned thin film transistor are formed thus forming a so-called pixel.

With respect to such a liquid crystal display device, a miniaturized liquid crystal display device has been popularly used as a display device of portable equipment such as a mobile phone. Further, recently, the liquid crystal display device which is basically used as a display device of portable equipment is also requested to perform a display of TV signals.

Following patent documents JP-A-09-236787 (patent document 1) and JP-A-2007-225891 (patent document 2) disclose a technique which can eliminate sticking of an image which occurs at the time of performing a display using interlace video signals on a liquid crystal display panel.

### SUMMARY OF THE INVENTION

With respect to a grayscale voltage supplied to a video signal line, to prevent a DC voltage from being applied to a liquid crystal capacity, for every 1 horizontal scanning period (hereinafter referred to as a frame), the polarity of the grayscale voltage is changed over between a grayscale voltage having a high potential with respect to a common voltage applied to a counter electrode (a grayscale voltage of positive polarity (+)) and a grayscale voltage having a low potential with respect to the common voltage (a grayscale voltage of negative polarity (−)) thus performing AC driving.

However, to consider a case where a liquid crystal display panel having a normally black characteristic is used and black and white are alternately displayed for every 1 frame, for example, when the grayscale voltage is changed in accordance with an alternating cycle of the liquid crystal such that “white display” is performed at the time of positive polarity and “black display” is performed at the time of negative polarity, the voltage of the pixel is deviated to the positive polarity side (plus side) with respect to the common voltage and hence, there arises a pattern in which a direct current is applied to the liquid crystal as an effective value. To the contrary, when the grayscale voltage is changed in accordance with an alternating cycle of the liquid crystal in which “black display” is performed at the time of positive polarity and “white display” is performed at the time of negative polarity, the voltage of the pixel is deviated to the negative polarity side (minus side) with respect to the common voltage and hence, there arises a pattern in which a direct current is applied to the liquid crystal as an effective value.

Particularly, such patterns often appear when a moving image is displayed. In this case, a DC signal is constantly applied to the liquid crystal and hence, display quality is lowered and, at the same time, a lifetime of liquid crystal per se is remarkably lowered.

Further, with respect to display data in which a white image and a black image are changed for every frame, such patterns often occur when an interlace (jump) scanning signal such as a television signal is converted into a progressive (sequential) scanning signal in liquid crystal driving. For example, in displaying a television image or a DVD image on a liquid crystal display device for appreciating such an image, a drive voltage of the liquid crystal is deviated thus giving rise to a possibility of deteriorating an image quality.

A display device used in portable equipment is also requested to perform a display of TV signals and hence, a display device of high definition which exhibits excellent display quality is also used in portable equipment.

However, to display TV signals in the liquid crystal display device, it is necessary to display interlace video signals and hence, it is necessary to prevent the above-mentioned deterioration of image quality.

The invention has been made to overcome the above-mentioned drawbacks of the related art, and it is an object of the invention to provide a miniaturized liquid crystal display device which can perform a high-quality display while coping with interlace video signals.

The above-mentioned and other objects and novel features of the invention will become apparent from the description of this specification and attached drawings.

To briefly explain the summary of typical inventions among the inventions disclosed in this specification, they are as follows.

According to the invention, a liquid crystal display device includes a liquid crystal display panel which is constituted of two substrates and a liquid crystal composition sandwiched between two substrates. The display panel includes a plurality of pixels. Each pixel includes a pixel electrode, a counter electrode which faces the pixel electrode in an opposed manner, and a switching element which is provided to the pixel electrode. Further, the display panel includes video signal lines each of which supplies a video signal to the switching elements of the respective pixels, scanning signal lines each of which supplies a control signal (scanning signal) for performing an ON/OFF control of the switching elements of the respective pixels, and a driver circuit which outputs the video signal to the video signal lines and outputs the control signal to the scanning signal lines.

While the driver circuit outputs the video signal whose polarity is inverted between an odd-numbered frame and an even-numbered frame, the driver circuit reverses the manner of inverting polarity of the video signal for every arbitrary number of frames. Accordingly, in one frame, the video signal having the same polarity as the preceding frame is outputted. When the video signal of the same polarity is outputted over two neighboring frames, signal processing which lowers brightness of the liquid crystal display device is performed in the succeeding frame.

To briefly explain advantageous effects obtained by the typical inventions among the inventions disclosed in this specification, they are as follows.

According to the invention, it is possible to provide a miniaturized liquid crystal display device which can perform a high-quality display while coping with interlace video signals.

### BRIEF DESCRIPTION OF THE DRAWINGS

FIG. 1 is a block diagram showing the basic constitution of a liquid crystal display device of an embodiment 1 according to the invention;

FIG. 2 is a schematic plan view showing a pixel portion of the liquid crystal display device of the embodiment 1 according to the invention;

FIG. 3 is a cross-sectional view taken along a line A-A in FIG. 2;

FIG. 4 is a view showing a scanning signal, a video signal and a counter voltage which is applied to a counter electrode when the liquid crystal display device adopts a so-called counter voltage inversion driving method in which a counter voltage supplied to the counter electrode is inverted at a fixed cycle;

FIG. 5 is a block diagram showing the schematic circuit constitution of a grayscale voltage generating circuit in a driver circuit shown in FIG. 1;

FIG. 6 is a block diagram showing the circuit constitution of a grayscale reference voltage generating circuit in the driver circuit;

FIG. 7 is a circuit diagram showing the circuit constitution of the reference voltage adjusting circuit shown in FIG. 6;

FIG. 8 is a graph showing the relationship between grayscales and grayscale voltages corresponding to the grayscales which are generated within a period of a first frame immediately after phase inversion and within a period of a usual frame in the liquid crystal display device of the embodiment according to the invention;

FIG. 9 is a view for explaining, in a liquid crystal display device of an embodiment 2 according to the invention, a video voltage written in a pixel within a period of a first frame immediately after phase inversion and a video voltage written in a pixel within a period of usual frame;

FIG. 10A and FIG. 10B are circuit diagrams showing one example of the circuit constitution of an output amplifying circuit shown in FIG. 5;

FIG. 11 is a view for explaining, in a liquid crystal display device of an embodiment 3 according to the invention, a video voltage written in a pixel within a period of a first frame immediately after phase inversion and a video voltage written in a pixel within a period of a usual frame;

FIG. 12 is a view for explaining 1 line inversion driving method which is one of counter voltage inversion driving methods shown in FIG. 4;

FIG. 13A and FIG. 13B are views showing the correspondence relationship between a video signal and a counter voltage when white and black are alternately displayed for every frame in the 1 line inversion driving method shown in FIG. 4;

FIG. 14 is a schematic view expressing polarities of pixels forever frame when phases of polarities of pixels are inverted at a fixed cycle in alternately displaying white and black for every frame as shown in FIG. 13; and

FIG. 15 shows a voltage waveform of a gate electrode, a voltage waveform of a source electrode and a voltage waveform of a counter electrode in one pixel when the display of intermediate grayscale is performed by adopting a phase inversion driving method.

### DESCRIPTION OF THE PREFERRED EMBODIMENTS

Hereinafter, embodiments of the invention are explained in detail in conjunction with drawings.

Here, in all drawings for explaining the embodiments, parts having identical functions are given same symbols and their repeated explanation is omitted.

### Embodiment

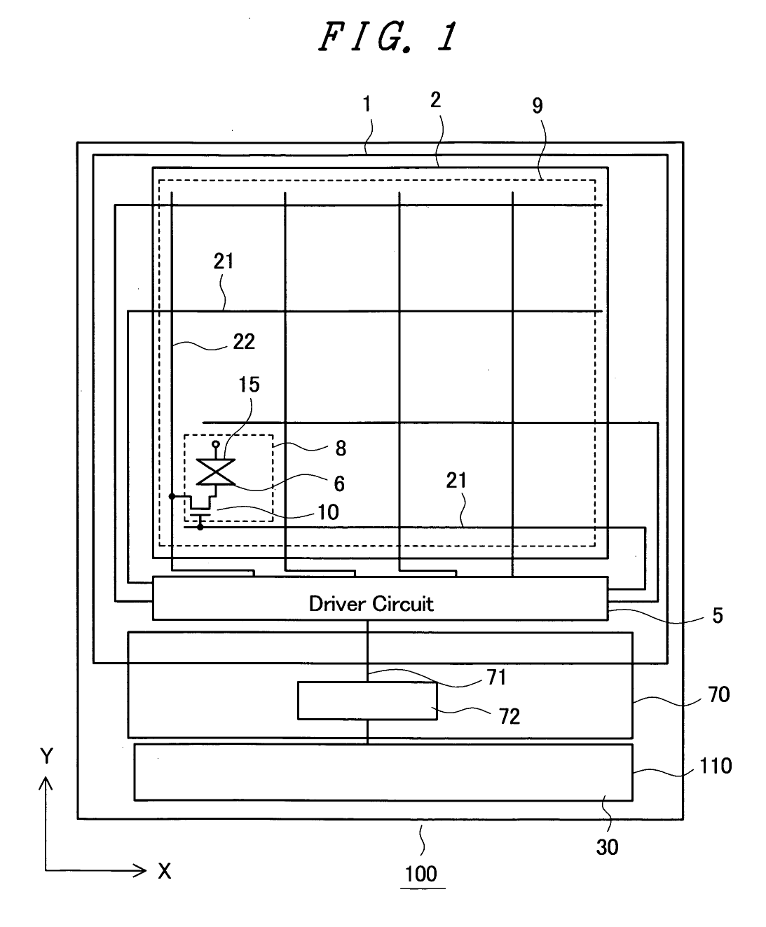

FIG. 1 is a block diagram showing the basic constitution of a liquid crystal display device of the embodiment 1 according to the invention. As shown in FIG. 1, the liquid crystal display device 100 of this embodiment is constituted of a liquid crystal display panel 2, a driver circuit 5, a flexible printed circuit board 70, a backlight 110 and a housing casing (not shown in the drawing).

The liquid crystal display pane 12 is configured as follows. A TFT substrate 1 on which a plurality of thin film transistors 10, a plurality of pixel electrodes 6 and the like are formed and a color filter substrate (not shown in the drawing) on which a plurality of counter electrodes 15, a plurality of color filters and the like are formed overlap with each other with a predetermined gap therebetween. Both substrates are adhered to each other using a frame-shaped sealing material arranged between both substrates and in the vicinity of peripheral portions of both substrates and, at the same time, liquid crystal composition is filled and sealed in a space defined by both substrates and the sealing material. Further, a polarizer is adhered to outer surfaces of both substrates.

Here, the invention is, as in the case of this embodiment, applicable to both of a so-called IPS-method type liquid crystal display panel in which the counter electrodes 15 are arranged on the TFT substrate 1 and a so-called vertical-electric-field method type liquid crystal display panel in which the counter electrodes 15 are arranged on the color filter substrate 3 in the same manner.

On the TFT substrate 1, a plurality of scanning signal lines (also referred to as gate lines) 21 which extends in the x direction and is arranged parallel to each other in the y direction in the drawing and a plurality of video signal lines (also referred to as drain signal lines) 22 which extends in the y direction and is arranged parallel to each other in the x direction in the drawing are formed, and a pixel portion 8 is formed in each region which is surrounded by the scanning signal lines 21 and the video signal lines 22.

Here, although the liquid crystal display panel 2 includes a large number of pixel portions (sub pixels) 8 in a matrix array, for facilitating the understanding of the drawing, only one pixel portion 8 is shown in FIG. 1. The pixel portions 8 arranged in a matrix array form a display region 9, the respective pixel portions 8 play a role of pixels of a display image, and an image is displayed in the display region 9.

The thin film transistor 10 of each pixel portion 8 has a source electrode thereof connected to the pixel electrode 6, has a drain electrode thereof connected to the video signal line 22, and has a gate electrode thereof connected to the scanning signal line 21. The thin film transistor 10 functions as a switch for supplying a grayscale voltage (video signal) to the pixel electrode 6. Here, although naming of “source electrode” and “drain electrode” may be reversed based on the relationship of biases, in this embodiment, the electrode which is connected to the video signal line 22 is referred to as the drain electrode, and the electrode which is connected to the pixel electrode 6 is referred to as the source electrode.

The driver circuit 5 is arranged on a transparent insulation substrate (glass substrate, resin substrate or the like) which constitutes the TFT substrate 1. The driver circuit 5 is electrically connected to the video signal lines 22 and the scanning signal lines 21.

A flexible printed circuit board 70 is connected to the TFT substrate 1. The flexible printed circuit board 70 includes a connector 72. The connector 72 is connected to an external signal line so as to allow inputting of signals to the flexible printed circuit board 70 from the outside. A line 71 is provided between the connector 72 and the driver circuit 5, and the signals from the outside are inputted to the driver circuit 5 via the line 71.

The liquid crystal display panel 2 is a non-light emitting element and hence, the liquid crystal display panel 2 requires a light source for displaying images. For this end, the liquid crystal display device 100 includes the backlight 110, and the backlight 110 emits light to the liquid crystal display panel 2. The liquid crystal display panel 2 performs a display by controlling a transmission quantity or a reflection quantity of light radiated from the backlight 110. Here, although the backlight 110 is arranged on a back surface or a front surface of the liquid crystal display panel 2, to facilitate the understanding of the drawing, the backlight 110 is illustrated such that the backlight 110 is juxtaposed to the liquid crystal display panel 2 in FIG. 1.

A control signal transmitted from a control device (not shown in the drawing) arranged outside the liquid crystal display device 100 and a power source voltage supplied from an external power source circuit (not shown in the drawing) are inputted to the driver circuit 5 via the connector 72 and the line 71.

Signals inputted to the driver circuit 5 from the outside are control signals including a clock signal, a display timing signal, a horizontal synchronizing signal, a vertical synchronizing signal and the like, display-use data (R·G·B) and a display mode control command. The driver circuit 5 drives the liquid crystal display panel 2 in response to the inputted signals.

The driver circuit 5, based on a reference clock generated inside the driver circuit 5, sequentially supplies a scanning voltage (control signal) of “High” level (hereinafter referred to as an H level) to the respective scanning signal lines 21 of the liquid crystal display panel 2 for every 1 horizontal scanning period. Due to such an operation, the plurality of thin film transistors 10 connected to each scanning signal line 21 of the liquid crystal display panel 2 allows the electrical conduction between the video signal lines 22 and the pixel electrodes 6 for 1 horizontal scanning period.

Further, the driver circuit 5 outputs a grayscale voltage corresponding to a grayscale to be displayed by the pixel to the video signal lines 22. When the grayscale voltage is supplied to the video signal lines 22, the grayscale voltage is supplied to the pixel electrodes 6 from the video signal lines 22 via the thin film transistors 10 in an ON (conductive) state. Thereafter, when the thin film transistors 10 are brought into an OFF state, the grayscale voltage based on a video to be displayed by the pixels is held in the pixel electrodes 6.

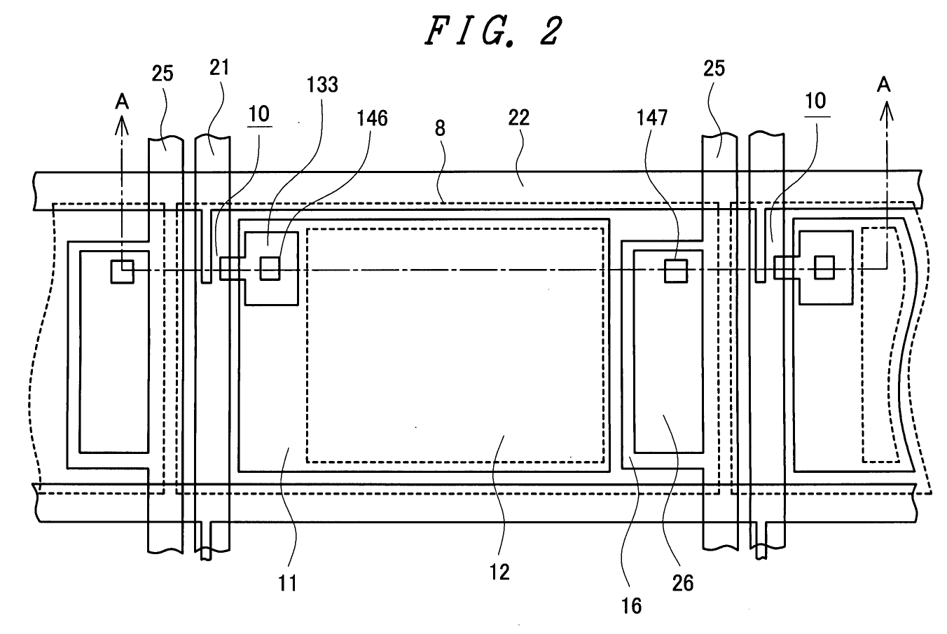

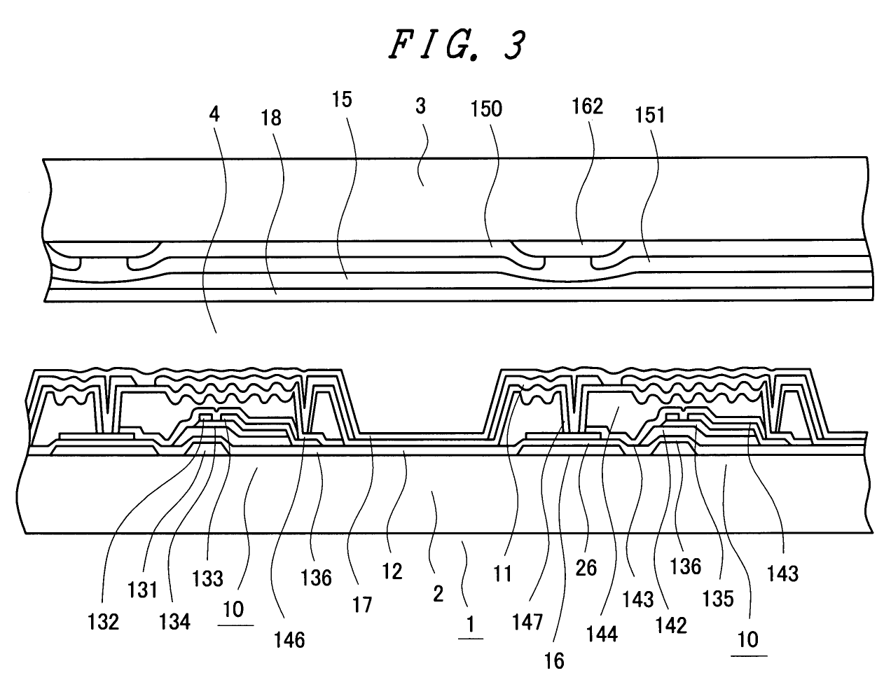

Next, FIG. 2 is a plan view of the pixel portion 8 of the liquid crystal display device 100. FIG. 3 is a cross-sectional view taken along a line A-A in FIG. 2. FIG. 2 and FIG. 3 show the pixel portion 8 of a transflective liquid crystal display panel which adopts a vertical-electric-field method.

As shown in FIG. 3, the counter electrodes 15 are formed on the color filter substrate 3 such that the counter electrode 15 faces a reflective region (hereinafter, also referred to as a reflective electrode) 11 and a transmissive region (hereinafter, also referred to as a transmissive electrode) 12 in an opposed manner.

Color filters 150 are formed on the color filter substrate 3 for respective colors consisting of red (R), green (G), and blue (B). A black matrix 162 is formed on a boundary between the respective color filters 150 for blocking light. Here, numeral 151 indicates an overcoat layer.

The TFT substrate 1 has at least a portion thereof made of transparent glass, a resin or the like. The scanning signal lines 21 are formed on the TFT substrate 1 as described previously. The scanning signal line 21 is formed of a multi-layered film consisting of a layer mainly made of chromium (Cr) or zirconium and a layer mainly made of aluminum (Al).

Here, capacity lines 25 are also formed on the TFT substrate 1 parallel to the scanning signal lines 21. An end portion of the reflective region 11 gets over the scanning signal line 21 and overlaps with the capacity line 25. The end portion of the reflective region 11 is arranged parallel to the scanning signal line 21, and the end portion of the reflective region 11 is arranged parallel to the video signal line 22.

The reflective region 11 is formed in a shape such that the reflective region 11 surrounds the transmissive region 12. The reflective region 11 is generally made of metal such as aluminum which does not allow light to pass therethrough and hence, the reflective region 11 possesses a function of a light blocking film compared to the transmissive region 12. In FIG. 2, for facilitating the understanding of the constitution of the pixel portion 8, the reflective region 11 is indicated by a dotted line.

The switching element (thin film transistor; TFT) 10 is arranged in the vicinity of an intersecting point of the scanning signal line 21 and the video signal line 22. The TFT 10 assumes an ON state in response to a scanning signal (control signal) of H level which is supplied to the TFT 10 via the scanning signal line 21, and writes a video signal supplied via the video signal line 22 into the transmissive electrode which forms the transmissive region 12 and the reflective electrode which forms the reflective region 11.

Next, the explanation is made in conjunction with the schematic cross-sectional view shown in FIG. 3. In the liquid crystal display panel 2, the TFT substrate land the color filter substrate 3 are arranged to face each other in an opposed manner. The liquid crystal composition 4 is held between the TFT substrate 1 and the color filter substrate 3. Between peripheral portions of the TFT substrate 1 and the color filter substrate 3, a sealing material (not shown in the drawing) is provided. The TFT substrate 1, the color filter substrate 3 and the sealing material form a container or an envelope which has a narrow gap, and the liquid crystal composition 4 is sealed between the TFT substrate 1 and the color filter substrate 3. Further, numerals 17 and 18 respectively indicate alignment films for controlling the alignment of the liquid crystal molecules.

The TFT 10 is formed by stacking a gate electrode 131, a drain electrode 132, a source electrode 133 and a semiconductor layer 134.

A portion of the scanning signal line 21 forms the gate electrode 131. Further, side surfaces of the gate electrode 131 are inclined such that a line width of the gate electrode 131 is increased toward a lower surface thereof on a TFT substrate 1 side from an upper surface thereof. A gate insulation film 136 is formed so as to cover the gate electrode 131, and the semiconductor layer 134 formed of an amorphous silicon film is formed on the gate insulation film 136.

An n⁺ layer 135 doped with impurities is formed on the semiconductor layer 134. The n⁺ layer 135 is an ohmic contact layer, and is formed so as to ensure the favorable electric connection of the semiconductor layer 134. The drain electrode 132 and the source electrode 133 are formed on the n⁺ layer 135 in a spaced-apart manner.

The video signal line 22, the drain electrode 132 and the source electrode 133 are formed of a multi-layered film which is constituted by sandwiching a layer mainly made of aluminum by two layers mainly made of an alloy of molybdenum (Mo) and chromium (Cr), molybdenum (Mo) or tungsten (W).

The source electrode 133 is electrically connected with the transmissive region 12 and the reflective region 11. Further, an inorganic insulation film 143 and an organic insulation film 144 are formed on the TFT substrate 1 so as to cover the TFT 10. The source electrode 133 is connected with the reflective region 11 and the transmissive region 12 via a through hole 146 formed in the inorganic insulation film 143 and the organic insulation film 144.

Here, the inorganic insulation film 143 may be formed using silicon nitride or silicon oxide, and the organic insulation film 144 may be formed of an organic resin film. Although a surface of the inorganic insulation film 143 and a surface of the organic insulation film 144 may be formed in a relatively flat shape, the surfaces may be formed to have unevenness.

The reflective region 11 is constituted of the reflective electrode. The reflective region 11 includes a conductive film made of metal such as aluminum which possesses a high optical reflectance on a light-radiation-side surface thereof. The conductive film is formed of a multi-layered film consisting of a layer which is mainly made of tungsten or chromium and a layer mainly made of aluminum. On the other hand, the transmissive region 12 is formed of a transparent conductive film. In the explanation made hereinafter, there may be a case that the reflective electrode is explained with numeral 11 added thereto and the transmissive electrode is explained with numeral 12 added thereto.

Here, the transparent conductive film is formed of a light-transmitting conductive layer made of ITO (Indium Tin Oxide), ITZO (Indium Tin Zinc Oxide), IZO (Indium Zinc Oxide), ZnO (Zinc Oxide), SnO (Tin oxide), In₂O₃ (Indium Oxide) or the like.

Further, the layer mainly made of chromium may be formed using only chromium or an alloy of chromium and molybdenum (Mo) or the like. The layer mainly made of zirconium may be formed using only zirconium or an alloy of zirconium and molybdenum or the like. The layer mainly made of tungsten may be formed using only tungsten or an alloy of tungsten and molybdenum or the like. The layer mainly made of aluminum maybe formed using only aluminum or an alloy of aluminum and neodymium or the like.

An uneven surface is formed on an upper surface of the organic insulation film 144 by photolithography or the like. Accordingly, an uneven surface is also formed on the reflective electrode 11 formed on the organic insulation film 144. By forming the uneven surface on the reflective electrode 11, a rate at which a reflection light scatters is increased.

Portions of the organic insulation film 144 and the inorganic insulation film 143 formed on the transparent electrode 12 are removed so as to form openings in the organic insulation film 144 and the inorganic insulation film 143. Here, the reflective electrode 11 is formed in a state that the reflective electrode 11 surrounds an outer periphery of the opening. Further, a side surface of the opening on a transmissive electrode 12 side is inclined, the reflective electrode 11 is formed on the inclined side surface, and the reflective electrode 11 is electrically connected with an outer peripheral portion of the transmissive electrode 12.

A holding capacity portion 16 is connected to a capacity line 25. Further, a holding capacity electrode 26 which faces the holding capacity portion 16 with the inorganic insulation film 143 sandwiched therebetween and forms a holding capacity with the holding capacity portion 16 is provided. The holding capacity electrode 26 and the reflective electrode 11 are connected with each other via a through hole 147 formed in the organic insulation film 144.

The holding capacity portions 16 can be, in the same manner as the capacity lines 25, formed by the same step and using the same material as the scanning signal lines 21. Further, the holding capacity electrodes 26 can be formed by the same step and using the same material as the video signal lines 22. Even when the holding capacity electrode 26 is connected to the transmissive electrode 12 besides the reflective electrode 11, the holding capacity electrode 26 can satisfy a function of a holding capacity electrode.

Next, FIG. 4 shows a scanning signal VSCN, a video signal VSIG and a counter voltage VCOM which is applied to the counter electrode when the liquid crystal display device adopts a so-called counter voltage inversion driving method in which a counter voltage VCOM supplied to the counter electrode 15 is inverted at a fixed cycle.

The scanning signal VSCN shown in FIG. 4 is a scanning signal outputted to the arbitrary scanning signal line 21. In FIG. 4, a period in which the scanning signal VSCN supplied to the scanning signal line 21 assumes a voltage VGON of H level is referred to as a 1 horizontal scanning period (1 H).

With respect to the counter voltage inversion driving method shown in FIG. 4, a so-called 1 line inversion driving method in which the counter voltage VCOM is inverted for every 1 horizontal scanning period is shown. By adopting the counter voltage inversion driving method, even when amplitude of the video signal VSIG is small, a large potential difference can be acquired between the video signal VSIG and the counter voltage VCOM and hence, low-voltage driving and low power consumption can be realized.

Symbol VSH of the video signal VSIG indicates that the grayscale voltage supplied to the pixel is a positive grayscale voltage constituting a signal of positive polarity with respect to the counter voltage VCOM. Symbol VSL of the video signal VSIG indicates that the grayscale voltage supplied to the pixel is a negative grayscale voltage constituting a signal of negative polarity with respect to the counter voltage VCOM.

Symbol VCOMH is a voltage of an H level of the counter voltage VCOM and symbol VCOML is a voltage of an L level of the counter voltage VCOM. The counter voltage VCOM is inverted between the voltage VCOMH and the voltage VCOML for every 1 horizontal scanning period (1 H).

Symbol VGON is a voltage of a H level of the scanning signal VSCN for turning on the TFT 10 of a pixel portion, and the voltage is required to be set to a value higher than a maximum value of the positive grayscale voltage VSH by an amount corresponding to a threshold voltage or more. Further, symbol VGOFF is a voltage of an L level of the scanning signal VSCN for turning off the TFT 10, and the voltage is required to be set to a value lower than a minimum value of the negative grayscale voltage VSL by an amount corresponding to a threshold voltage or more.

In this 1 line inversion driving method, as shown in FIG. 12, the polarity is inverted for every 1 line and, at the same time, the polarity is inverted for every frame. In FIG. 12, symbol 110 indicates the pixels having positive polarity (the pixels indicated by + in FIG. 12) and the pixels of negative polarity (the pixels indicated by − in FIG. 12) in one frame, and symbol 120 indicates the pixels having positive polarity (the pixels indicated by + in FIG. 12) and the pixels of negative polarity (the pixels indicated by − in FIG. 12) in a succeeding frame (next frame).

### [Drawbacks Which Arise in 1 Line Inversion Driving Method]

In displaying a still image, positive polarity and negative polarity are applied to the respective pixels without deviation on a time-wise average in 1 line inversion driving method. However, when white is displayed in one frame, black is displayed in the succeeding frame, and white is displayed in a frame next to the above-mentioned succeeding frame, that is, white and black are alternately displayed for every frame, polarities are applied to respective pixels in a deviated manner on a time-wise average.

This point is explained hereinafter.

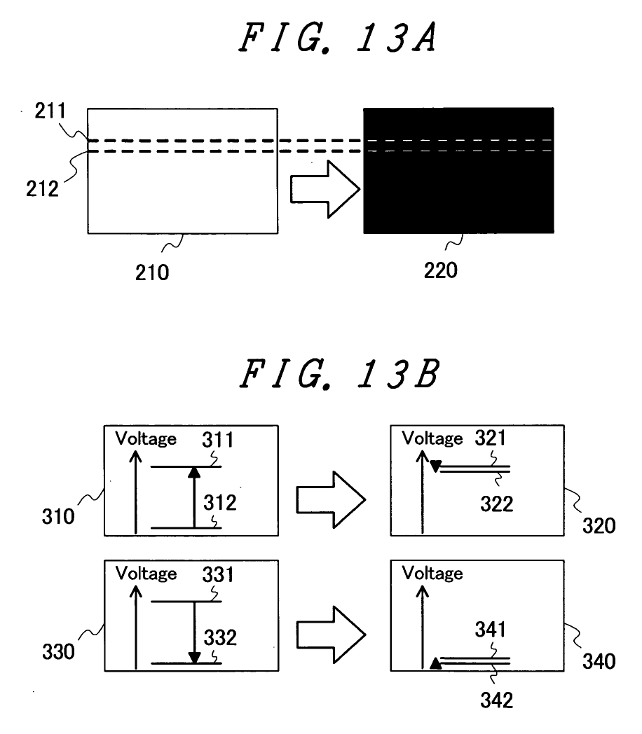

FIG. 13A and FIG. 13b are views showing the correspondence relationship between the video signal VSIG and the counter voltage VCOM when white and black are alternately displayed for every frame in the 1 line inversion driving method shown in FIG. 4.

In FIG. 13A, symbol 210 indicates an odd-numbered frame, and symbol 220 indicates an even-numbered frame. In FIG. 13A, white is displayed in the odd-numbered frame 210 and black is displayed in the even-numbered frame 220.

Symbol 211 indicates a display line in the odd-numbered frame 210 and the even-numbered frame 220, and symbol 212 indicates a line next to the display line 211. Assume that positive polarity is written in the display line 211 and negative polarity is written in the display line 212 in the odd-numbered frame 210. In this case, negative polarity is written in the display line 211 and positive polarity is written in the display line 212 in the even-numbered frame 220.

FIG. 13B shows a counter voltage (VCOM) and a grayscale voltage of the display line 211 and the display line 212. Here, the liquid crystal display panel having a normally black characteristic is considered.

Symbol 310 indicates a voltage level of the display line 211 in the odd-numbered frame 210, and symbol 320 indicates a voltage level of the display line 211 in the even-numbered frame 220. In the same manner, symbol 330 indicates a voltage level of the display line 212 in the odd-numbered frame 210, and symbol 340 indicates a voltage level of the display line 212 in the even-numbered frame 220.

Further, symbol 311 indicates a voltage level of the grayscale voltage, symbol 312 indicates a voltage level of the counter voltage, symbol 321 indicates a voltage level of the counter voltage, and symbol 322 indicates a voltage level of the grayscale voltage. In the same manner, symbols 331, 332 respectively indicate voltage levels of the counter voltage and the grayscale voltage, and symbols 341, 342 respectively indicate voltage levels of the grayscale voltage and the counter voltage.

As can be understood from FIG. 13B, with respect to the display line 211, the large voltage of positive polarity (grayscale voltage>counter voltage) is applied in the odd-numbered frame 210 and the small voltage of negative polarity (counter voltage>grayscale voltage) is applied in the even-numbered frame 220. Further, with respect to the display line 212, the large voltage of negative polarity (counter voltage>grayscale voltage) is applied in the odd-numbered frame 210 and the small voltage of positive polarity (grayscale voltage>counter voltage) is applied in the even-numbered frame 220.

Accordingly, to take a time-wise average, voltages which are deviated to the positive polarity are applied to the pixels on the display line 211, and the voltages which are deviated to the negative polarity are applied to the pixels on the display line 212. Image retention occurs when the voltages which are deviated to the positive polarity or the negative polarity are applied to the pixels of the liquid crystal display panel and hence, an image retention occurs when the image which inverts white and black for every frame is displayed.

To overcome the above-mentioned drawback, according to the invention, a method of inverting polarity is changed over for a fixed cycle (for example, 2048 frames). Hereinafter, in this specification, this AC driving method is referred to as a phase inversion driving method.

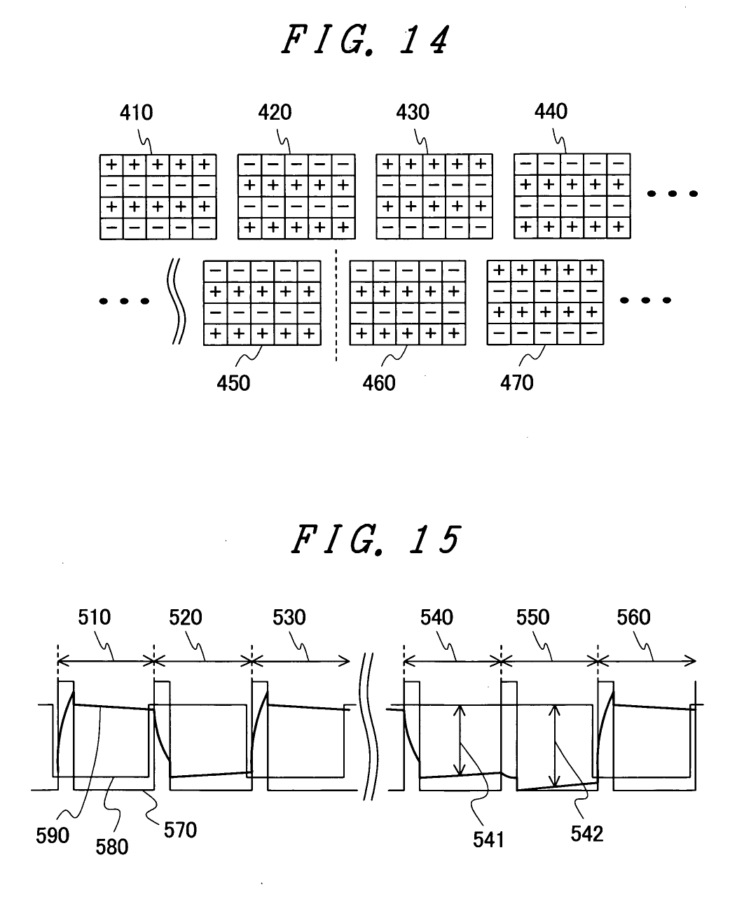

FIG. 14 is a schematic view expressing polarities of pixels for every frame when phases of polarities of pixels are inverted at a fixed cycle in alternately displaying white and black for every frame as shown in FIG. 13.

In FIG. 14, symbol 410 indicates polarities of pixels in the first frame, symbol 420 indicates polarities of pixels in the second frame, and symbols 430, 440, 450, 460, 470 respectively indicate polarities of pixels in the third, the forth, the 2048^{th}, the 2049^{th} and the 2050^{th} frames. Further, symbol (+) indicates writing of positive polarity and symbol (−) indicates writing of negative polarity.

According to this phase inversion driving method, even when an image which inverts black and white for every frame is displayed, for example, although the voltage is deviated to positive polarity from the first frame to the 2048^{th} frame, the voltage is deviated to negative polarity from 2049^{th} to the 4096^{th} frame and hence, the deviation of the voltage can be eliminated on a time-wise average.

In this manner, by performing AC driving such that the deviation of the voltage of the pixel assumes the positive polarity side and the negative polarity side at a fixed cycle, eventually, the effective DC voltage applied to the liquid crystal can be reduced.

However, when an intermediate grayscale display, for example, a gray matted display in 127 grayscales is performed by this phase inversion driving method, there arises a phenomenon such as a flash in which the brightness of all screen is increased in the 2049^{th} frame where the polarity inversion method is changed over.

FIG. 15 shows a voltage waveform of a gate electrode, a voltage waveform of a source electrode and a voltage waveform of a counter electrode in one pixel when the display of intermediate grayscale is performed by adopting the phase inversion driving method.

In FIG. 15, symbol 570 indicates the voltage waveform of the gate electrode, symbol 580 indicates the voltage waveform of the counter electrode, and symbol 590 indicates the voltage waveform of the source electrode. Further, symbols 510, 520, 530 respectively indicate the first frame, the second frame and the third frame, and symbols 540, 550, 560 respectively indicate the 2048^{th} frame, the 2049^{th} frame and the 2050^{th} frame.

Symbols 541, 542 in FIG. 15 respectively indicate voltages which are directly applied to the liquid crystal in the 2048^{th} frame and the 2049^{th} frame. Since the same polarity continues in the 2048^{th} frame and the 204 9^{th} frame, the 2049^{th} frame can acquire a predetermined voltage with writing of a small voltage. Accordingly, a voltage difference is generated between the voltage 541 which is to be written in the 2048^{th} frame with writing of a large voltage and the voltage 542 which is to be written in the 2049^{th} frame with writing of the small voltage and hence, the brightness difference arises thus giving rise to the above-mentioned phenomenon such as a flash.

Accordingly, in this embodiment, when the polarity of the pixel continues such that {(−)→(−)} or {(+)→(+)} due to the phase inversion driving method, in the first frame immediately after the phase inversion, the voltage applied to the pixel is lowered compared to a usual voltage thus preventing the above-mentioned flash (the increase of brightness).

Hereinafter, explained is a method of this embodiment in which the voltage applied to the pixel within the first frame immediately after the phase inversion (hereinafter referred to as a frame A) is lowered than the voltage applied to the pixel within the usual frame (hereinafter referred to as a frame B).

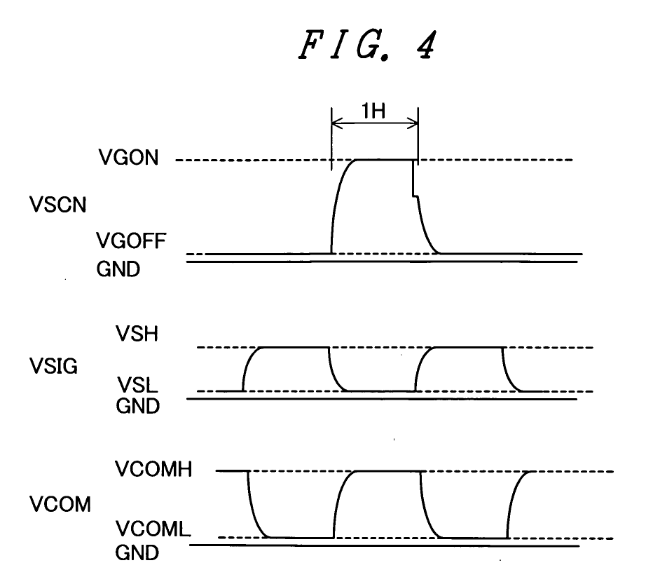

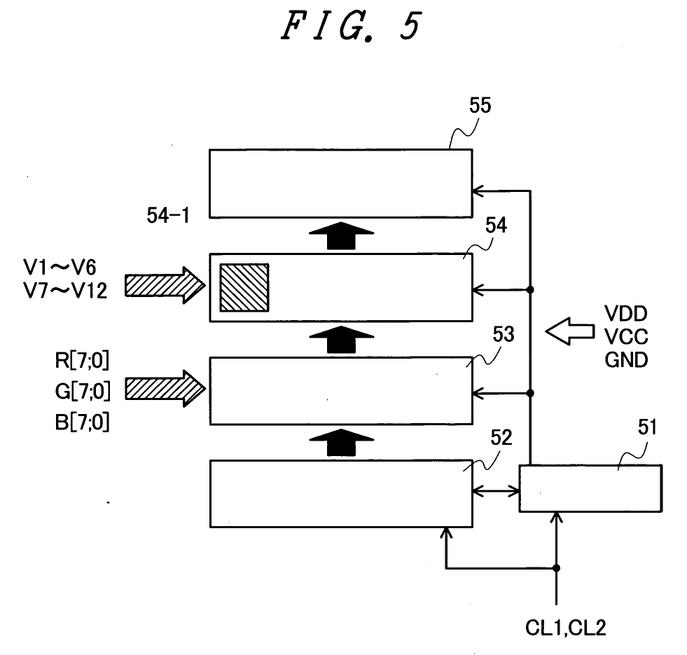

FIG. 5 is a block diagram showing the schematic circuit constitution of the grayscale voltage generating circuit in the driver circuit 5 shown in FIG. 1.

In FIG. 5, symbol 51 indicates a clock control part, symbol 52 indicates a latch address selector, symbol 53 indicates a latch circuit, symbol 54 indicates a D/A converter circuit, and symbol 55 indicates an output amplifying circuit.

A latch circuit 53 sequentially latches inputted display data (R[7:0], G[7:0], B[7:0]) in synchronism with a display data latch clock (CL2) outputted from the display control part in the driver circuit 5 under a control of the latch address selector 52.

The display data latched by the latch circuit 53 is outputted to a D/A converter circuit 54 based on an output timing control clock signal (CL1) outputted from a display control part in the driver circuit 5.

The D/A converter circuit 54 includes a grayscale voltage generating circuit (54-1) which generates grayscale voltages of 0 to 255 grayscales having positive polarity and negative polarity based on grayscale reference voltages inputted from the grayscale reference voltage generating circuit 740 in the driver circuit 5, for example, grayscale reference voltages of V1 to V6 having positive polarity and grayscale reference voltages of V7 to V12 having negative polarity.

The D/A converter circuit 54 selects a grayscale voltage corresponding to display data outputted from the latch circuit 53 out of the grayscale voltages of 0 to 255 grayscales having positive polarity and negative polarity which are generated by the grayscale voltage generating circuit (54-1) which is constituted of a resistance voltage dividing circuit, and inputs the selected grayscale voltage to the output amplifying circuit 55.

The output amplifying circuit 55 performs the current amplification of the grayscale voltage inputted from the D/A converter circuit 54 by an amplifying circuit, and outputs the grayscale voltage to the corresponding video signal line 22.

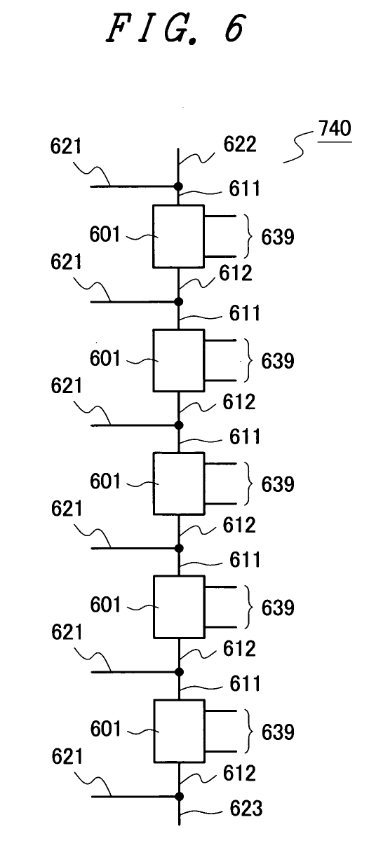

FIG. 6 is a block diagram showing the circuit constitution of a grayscale reference voltage generating circuit 740 in the driver circuit 5.

The grayscale reference voltage generating circuit 740 shown in FIG. 6 divides a voltage applied between terminals 622, 623 by reference voltage adjusting circuits 601 connected in series thus outputting, for example, grayscale reference voltages of V1 to V6 having positive polarity and grayscale reference voltages of V7 to V12 having negative polarity from output terminals 621 connected to inputs 611 or outputs 612.

In the grayscale reference voltage generating circuit 740 shown in FIG. 6, by changing resistances in the reference voltage adjusting circuits 601, a rate of dividing the voltage applied between the terminals 622, 623 can be changed. That is, in response to control signals inputted to control terminals via a group of control signal lines 639 (control signal lines 631 to 638), the grayscale reference voltages outputted from the output terminals 621 of the grayscale reference voltage generating circuit 740 can be changed.

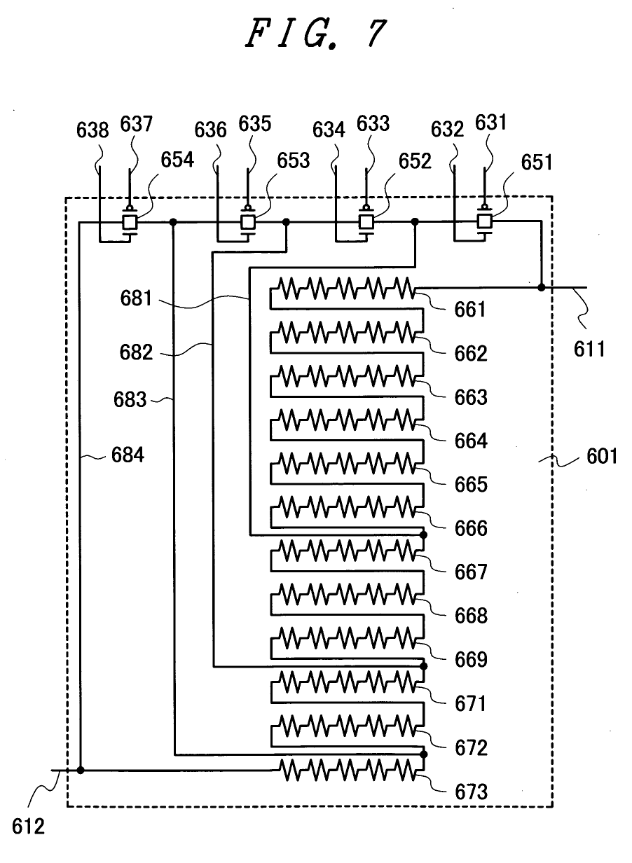

FIG. 7 is a circuit diagram showing the circuit constitution of the reference voltage adjusting circuit 601 shown in FIG. 6.

The reference voltage adjusting circuit 601 is constituted of resistances 661 to 673 which are connected in series, and analog switches 651, 652, 653, 654 which are connected in parallel between some resistances.

The input 611 is connected to the resistance 661 the analog switch 651. The other terminal of the analog switch 651 is connected to the resistance 666 via a line 681.

The respective resistances 661, 662, 663, 664, 665, 666 are connected in series, and an input and an output of the resistances which are connected in series can be short-circuited by the analog switch 651.

When the control signal line 631 assumes a voltage of L level and the control signal line 632 assumes a voltage of H level, the input and the output of the resistances 661, 662, 663, 664, 665, 666 are short-circuited and hence, apparent resistance values of these resistances 661, 662, 663, 664, 665, 666 become zero.

In the same manner, when the analog switch 652 is turned on in response to control signals from the control signal lines 633, 634, an input and an output of the resistances 667, 668, 669 can be short-circuited. When the analogs witch 653 is turned on in response to control signals from the control signal lines 635, 636, an input and an output of the resistances 671, 672 can be short-circuited. Further, when the analog switch 654 is turned on in response to control signals from the control signal lines 637, 638, an input and an output of the resistance 673 can be short-circuited.

For example, when the analog switch 651 is turned on, an operation state can be changed over from a state in which 12 resistances are connected in series between the input 611 and the output 612 to a state in which 6 resistances are connected in series between the input 611 and the output 612 thus enabling a change of a resistance value between the input 611 and the output 612.

The grayscale reference voltage generating circuit 740 outputs the grayscale reference voltage corrected within the period of frame A (first frame immediately after phase inversion) to the grayscale voltage generating circuit (54-1), and outputs the usual grayscale reference voltage to the grayscale voltage generating circuit (54-1) within the period of frame B (usual frame).

FIG. 8 shows the relationship between grayscales (K) and the grayscale voltages (KV) corresponding to the grayscales (K) which are generated within the period of frame A and within the period of frame B in this embodiment.

Symbol 620 shown in FIG. 8 indicates the relationship between grayscales (K) and grayscale voltages (KV) corresponding to the grayscales (K) which the grayscale voltage generating circuit (54-1) generates based on the corrected grayscale reference voltage within the period of frame A, and symbol 610 indicates the relationship between each grayscales (K) and the grayscale voltage (KV) which the grayscale voltage generating circuit (54-1) generates based on the usual grayscale reference voltage within the period of frame B. Here, in FIG. 8, the respective grayscales (K) and the grayscale voltages (KV) within the period of frame B are standardized to exhibit a linear proportional relationship.

As indicated by symbol 620 in FIG. 8, in this embodiment, even when the intermediate grayscale is equal, the grayscale voltage generated within the period of frame A is smaller than the grayscale voltage generated within the period of frame B. That is, at the same intermediate grayscale, the brightness acquired by the grayscale voltage generated within the period of frame A becomes lower than the brightness acquired by the grayscale voltage generated within the period of frame B.

Accordingly, in this embodiment, it is possible to prevent the above-mentioned flash (the increase of brightness) in the first frame A immediately after phase inversion.

FIG. 8 substantially expresses y characteristic of the liquid crystal display panel. In this embodiment, FIG. 8 substantially expresses a change of y characteristic of the liquid crystal display panel within the period of frame A.

In this embodiment, the grayscale reference voltage generating circuit 740 may be also configured such that the grayscale reference voltage is set equal within both of the period of frame A and the period of frame B without changing the grayscale reference voltage within the period of frame A, and inputted display data (Din) is subject to calculation within the period of frame A, and the grayscale voltage generated based on the display data after calculation satisfies the characteristic indicated by symbol 620 in FIG. 8.

### Embodiment 2

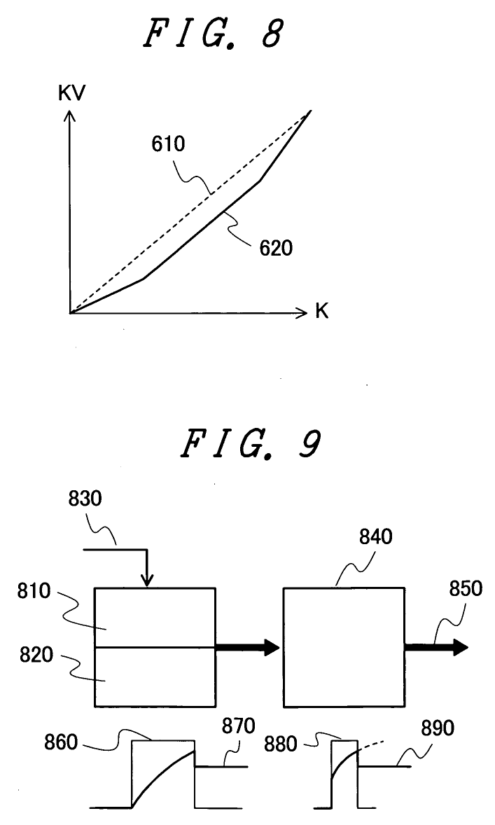

In this embodiment, as shown in FIG. 9, a length of 1 horizontal scanning period 880 within the period of frame A (first frame immediately after phase inversion) is set smaller than 1 horizontal scanning period 860 within the period of frame B (usual frame).

According to this embodiment, a writing time of a video voltage to a pixel within 1 horizontal scanning period within the period of frame A becomes shorter than a writing time of a grayscale voltage to a pixel within 1 horizontal scanning period within the period of frame B. Accordingly, it is possible to set the potential difference between the video voltage (indicated by symbol 890 in FIG. 9) written in the pixel within the period of frame A and the video voltage (indicated by symbol 870 in FIG. 9) written in the pixel within the period of frame B to substantially 0V. Accordingly, it is possible to prevent the occurrence of the above-mentioned flash in the first frame immediately after the phase inversion.

For this end, in this embodiment, the driver circuit also includes an H level width setting register 810 which is operated within the period of frame B, and an H level width setting register 820 which is operated within the period of frame A. When a pulse 830 indicative of the 2049^{th} frame is inputted, a value of the register 820 is read, and a clock generating circuit 840 generates a clock 850 having a small pulse width of H level. On the other hand, when the pulse 830 indicative of the 2049^{th} frame is not inputted, a value of the register 810 is read, and the clock generating circuit 840 generates a clock 850 having a large pulse width of H level.

An ON period of a gate of the TFT 10 is changed using this clock 850 so as to set the writing time of the video voltage in the pixel within 1 horizontal scanning period within the period of frame A shorter than the writing time of the grayscale voltage in the pixel within 1 horizontal scanning period within the period of frame B.

FIG. 9 is a view for explaining, in the liquid crystal display device of the embodiment 2, the video voltage written in the pixel within the period of the first frame immediately after the phase inversion and the video voltage written in the pixel within the period of usual frame. The circuit shown in FIG. 9 is incorporated in the driver circuit 5.

### Embodiment 3

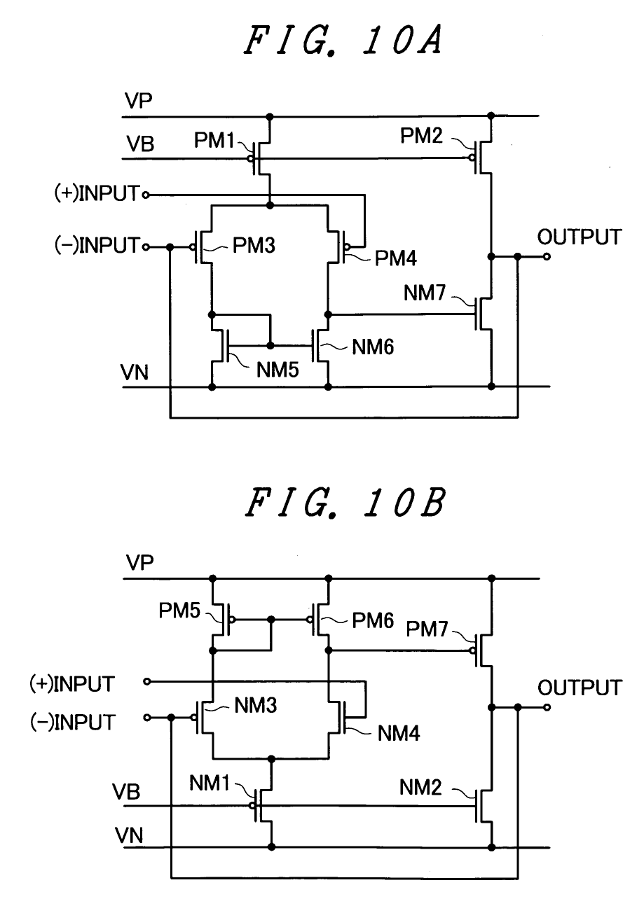

FIG. 10A and FIG. 10B are circuit diagrams showing one example of the circuit constitution of an output amplifying circuit 55 shown in FIG. 5. FIG. 10A shows an amplifying circuit which outputs the grayscale voltage of negative polarity, and FIG. 10B shows an amplifying circuit which outputs the grayscale voltage of positive polarity.

The amplifying circuits shown in FIG. 10 are constituted of a well-known voltage follower circuit which is formed by connecting an output terminal and a (−) input terminal of a differential amplifying circuit which is constituted of p-type transistors (PM1 to PM7) and n-type transistors (NM1 to NM7).

In the amplifying circuit shown in FIG. 10, for example, when a voltage value of a bias power source VB shown in FIG. 10B is changed so that an electric current which flows in the transistors (NM1, NM2) constituting a constant current source is increased, a distributed capacity of the video signal line 22 or an electric current for charging a pixel capacity can be decreased via the video signal line 22 and hence, a time necessary for rising the voltage of the source electrode (that is, the pixel electrode 6) of the TFT 10 to a normal grayscale voltage can be prolonged. That is, by decreasing the current value of the constant-current source of the output amplifying circuit 55, rising of the voltage of the pixel electrode 6 to the normal grayscale voltage can be delayed.

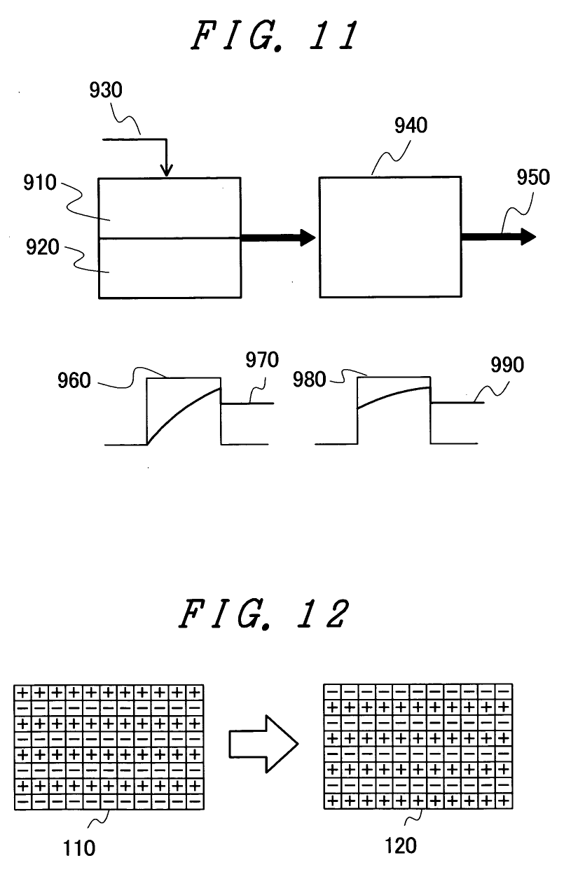

In this embodiment, with the use of such a phenomenon, by decreasing the current value of the constant-current source of the output amplifying circuit 55 in the 2049^{th} frame, the rising of the voltage of the pixel electrode 6 to the normal grayscale voltage within 1 horizontal scanning period 980 can be delayed and hence, it is possible to set the potential difference between the video voltage (indicated by symbol 990 in FIG. 11) written in the pixel within the period of frame A and the video voltage (indicated by symbol 970 in FIG. 11) written in the pixel within 1 horizontal scanning period 960 within the period of frame B to substantially 0V. Accordingly, it is possible to prevent the occurrence of the above-mentioned flash in the first frame immediately after the phase inversion.

For this end, in this embodiment, as shown in FIG. 11, the driver circuit also includes a constant-current setting register 910 which is operated within the period of frame B (usual frame) and a constant-current setting register 920 which is operated within the period of frame A (first frame immediately after phase inversion).

Then, when the pulse 930 indicative of the 2049^{th} frame is inputted, a value of the register 920 is read, and a current value of the constant-current source of the output amplifying circuit 940 is decreased. On the other hand, when the pulse 930 indicative of the 2049^{th} frame is not inputted, the value of the register 910 is read, and a current value of the constant-current source of the output amplifying circuit 940 is set to a usual current value. Then, the output amplifying circuit 940 performs the current amplification at the respective current values of the constant-current source and outputs a grayscale voltage 950.

FIG. 11 is a view for explaining, in the liquid crystal display device of the embodiment 3, the video voltage written in the pixel within the period of the first frame immediately after the phase inversion and the video voltage written in the pixel within the period of usual frame. The circuit shown in FIG. 11 is incorporated in the driver circuit 5.

Although the invention made by inventors of the invention has been specifically explained based on the embodiments, it is needless to say that the invention is not limited to such embodiments, and various modifications can be made without departing from the gist of the invention.

What is claimed is:

1. A liquid crystal display device having a liquid crystal display panel which includes:
a first substrate;
a second substrate;
a liquid crystal composition which is sandwiched between the first substrate and the second substrate;
a pixel region which is formed of a plurality of pixels arranged in a matrix array on the first substrate, each pixel including a pixel electrode, a counter electrode which faces the pixel electrode in an opposed manner, and a switching element which is electrically connected with the pixel electrode; and
a driver circuit which is mounted on the first substrate along a first side of the pixel region, wherein the driver circuit is configured to rewrite a video signal in each pixel of the pixel region for every 1 frame period via the switching element,
the driver circuit includes a first AC driving mode in which polarity of a video signal to be rewritten in a frame period succeeding to the 1 frame period is inverted, and a second AC driving mode in which the polarity of the video signal to be rewritten in the succeeding frame period is equal to polarity of the video signal in the 1 frame period, and
a reference voltage of the video signal is corrected so as to decrease brightness of the pixel in the second AC driving mode.

2. A liquid crystal display device according to claim 1, wherein the correction is made to change a value of gamma correction.

3. A liquid crystal display device according to claim 1, wherein the correction is made to correct the reference voltage generated in the driver circuit.

4. A liquid crystal display device according to claim 1, wherein the reference voltage is generated by a reference voltage generating circuit in the driver circuit, and the reference voltage generating circuit executes the correction.

5. A liquid crystal display device according to claim 1, wherein the reference voltage is generated by a reference voltage generating circuit in the driver circuit, and the correction is executed based on a control signal inputted to the reference voltage generating circuit in the driver circuit.

6. A liquid crystal display device having a liquid crystal display panel which includes:
a first substrate;
a second substrate;
a liquid crystal composition which is sandwiched between the first substrate and the second substrate;
a plurality of pixels each of which includes a pixel electrode, a counter electrode which faces the pixel electrode in an opposed manner and to which a common voltage is supplied, and a switching element which is electrically connected with the pixel electrode;
video signal lines which supply a video signal to the respective pixels;
scanning signal lines which supply a control signal to the respective pixels; and
a driver circuit which outputs the video signal to the video signal lines, and outputs a control signal for performing an ON/OFF control of the switching element of each pixel to the scanning signal lines, wherein
the driver circuit is mounted on the first substrate,
the driver circuit includes a first writing mode in which polarity of the writing video signal is inverted in rewriting the video signal of the same pixel, and a second writing mode in which the video signal is written with the same polarity in rewriting the video signal to the same pixel, and
a reference voltage of the video signal is corrected so as to decrease brightness of the pixel in the second writing mode.

7. A liquid crystal display device according to claim 6, wherein the correction is made to change a value of gamma correction.

8. A liquid crystal display device according to claim 6, wherein the correction is made to correct the reference voltage generated in the driver circuit.

9. A liquid crystal display device according to claim 6, wherein the reference voltage is generated by a reference voltage generating circuit in the driver circuit, and the reference voltage generating circuit executes the correction.

10. A liquid crystal display device having a liquid crystal display panel which includes:
a first substrate;
a second substrate;
a liquid crystal composition which is sandwiched between the first substrate and the second substrate;
a plurality of pixels each of which includes a pixel electrode, a counter electrode which faces the pixel electrode in an opposed manner and to which a common voltage is supplied, and a switching element which is electrically connected with the pixel electrode;
video signal lines which supply a video signal to the respective pixels;
scanning signal lines which supply control signals to the respective pixels; and
a driver circuit which outputs the video signal to the video signal lines, wherein
the driver circuit is mounted on the first substrate and has an amplifying circuit which outputs the video signal to the respective video signal lines,
the driver circuit includes a first writing mode in which polarity of the writing video signal is inverted in rewriting the video signal of the same pixel, and a second writing mode in which the video signal is written with the same polarity in rewriting the video signal to the same pixel, and
a current value of a constant-current source of the amplifying circuit is corrected so as to decrease brightness of the pixel in the second writing mode.
